(19) United States
(12) Patent Application Publication
(10) Pub. No.: US 2011/0154108 A1
(43) Pub. Date: Jun. 23, 2011

(54) SYSTEM AND PROCESS FOR SIMULATION OR TEST EXPLOITING DATA FROM MONITORING PORTS

(75) Inventor: Fabrice CANDIA, Rieux (FR)

(73) Assignee: AIRBUS OPERATIONS (SAS), Toulouse (FR)

(21) Appl. No.: 12/970,136

(22) Filed: Dec. 16, 2010

(30) Foreign Application Priority Data
Dec. 16, 2009 (FR) 09 59077

(51) Int. Cl. G06F 11/07

(52) U.S. Cl. 714/25; 714/E11.024

(57) ABSTRACT

The present invention relates to a system for simulating/testing an aeronautic computer network architecture, especially installed on board an aircraft, and to a corresponding method.

The system comprises:

a communication network (2) comprising a plurality of switches (SW1-SW8);

a plurality of real computers (11-14) connected to the network at the corresponding switches (SW1-SW4);

a simulation unit (100) simulating at least one computer (15-17) of the said architecture and connected to the network at at least one corresponding switch (SW5-SW8), and

a third switch (42), which receives, at input ports (PE), data (Mess₁₃, Mess₁₇) acquired at the monitoring ports (PM) of the said corresponding switches and emitted by the said computers over the network, the third switch being configured to duplicate the said data over a plurality of output ports (UTAPⱼ OB1ⱼ, AFDXIFⱼ, OTiⱼ), to which a plurality of consuming applications (100, 110, UTAP, OBi, OTi) is connected.

### FIELD OF THE INVENTION

The present invention relates to a system for simulating or testing an aeronautic computer network architecture, especially installed on board an aircraft, and to a corresponding method.

### BACKGROUND OF THE INVENTION

The development of real systems is currently achieved progressively with the aid of simulation systems. These systems make it possible not only to visualize and test projects in progress but also to make them evolve rapidly and at lower costs.

This is the case in particular in the aeronautic sector, where there are used simulation systems in which on-board equipment items, also known as real computers or LRUs (“Line Replaceable Units”), are integrated with modules simulating other on-board equipment items.

In the recent aircraft versions, the real computers are integrated into a digital network architecture of Ethernet type adapted to aeronautics and known as ADCN (“Avionics Data Communication Network”), which uses the AFDX technology (“Avionics Full DupleX switched Ethernet”). This network is composed of switches, via which the computers communicate.

In this network, the communications between computers are achieved in non-connected multi-broadcasting (multicast) mode, meaning that the data recipient or recipients does not or do not acknowledge reception to the emitter. The paths that the different data take are organized in the form of virtual links (“Virtual Link” or “VL”). A virtual link is a logical path via different switches of the network between an emitter computer and n receiver computers.

These virtual links make it possible to define as many logical paths as necessary, leakproof with respect to one another and having guaranteed performances despite using a common physical network. The set of these virtual links constitutes the logical topology of the network. To guarantee the required performances and to satisfy the constraints of aeronautic certification, this logical topology is defined statically.

Over the physical network, the data exchanged between the computers are able to transit via one or more switches according to the physical topology of the ADCN network.

French Patent 2868567 presents a simulation system intended for such an avionics architecture. In this system, a simulation unit comprises models simulating all or part of the real computers (in the manner of software routines composed from computer functions then simulated) and AFDX communication functions with the real ADCN network to which it is connected. The simulation models are integrated into the ADCN digital network via the communication functions. By virtue of this integration, the simulation models communicate with one another or with on-board equipment items under conditions as close as possible to those encountered in the real aircraft.

There is known the document “Evaluation of the real-time performances of avionic on-board networks” (H. Charara, 2007), which models such an AFDX avionics network and the traffic circulation therein according to virtual links VL, by suppressing paths said to be “not influencing or indirectly influencing”.

In general, to interact with the simulations and/or to follow the tests being conducted, there are used dedicated tools, such as instrumentation and analysis tools, or mobile tools shared between several systems, connected temporarily at user access points provided in the simulation system to tap information items circulating in this system. These tools, generally employed in the form of software applications external to the simulation unit, are consumers of information items being transported in the network, and especially the messages emitted by the various real or simulated computers.

The recovery of messages may be employed in various ways.

On the one hand, the simulation unit may be used to retransmit, to these tools, the messages emitted by the computers and that it recovers for the purpose of supplying the simulation models. However, this solution leads to an additional processing load for the simulation unit. In addition, since all of the messages are necessary for the tools, the simulation unit must then acquire the real inter-computer messages (which are therefore not necessarily used by the simulation models), further increasing its processing load.

On the other hand, it is possible to envision tools for acquisition of messages circulating on the network. Nevertheless, such acquisition must be performed on all the segments of the network on which a given message may transit, and it therefore produces numerous duplicates of messages. This also results in a nonproductive overload for the acquisition equipment as well as in possible processing operations aimed at suppressing the duplicates before transmission to the tools.

The present invention relates to solving at least one of the problems of the prior art by efficient arrangement of a switch, especially of those available on shelves, together with the switches of the network (in this case ADCN) and to efficient use thereof.

### SUMMARY OF THE INVENTION

For this purpose, the invention relates in particular to a system for simulating or testing an aeronautic computer network architecture, the system comprising:

a communication network comprising a plurality of switches;

a plurality of real computers connected to the network respectively at one of the switches, referred to as corresponding switch; and

a simulation unit simulating at least one computer of the said architecture and connected to the network at at least one switch referred to as corresponding switch,

characterized in that the said system comprises:

a switch, referred to as third switch, which receives, at the input ports, data acquired at the monitoring ports of the said corresponding switches and emitted by the said computers (especially real or simulated) over the network,

the third switch being configured to duplicate the said data over a plurality of output ports, to which a plurality of consuming applications is connected.

The third switch makes it possible to distribute a copy of messages being broadcast on the network without additional processing either from the simulation unit or from any other active equipment item of the network.

Furthermore, the use of monitoring ports (also known as “ports monitoring”) makes it possible to limit the acquisition of messages to a single instance. In fact, a network switch produces, over its monitoring ports, only one copy of the messages emitted by the computers directly connected to it. Thus the acquisition of messages at the other switches does not end in acquisition of a new copy of the already acquired message. In addition, since every computer is connected to a corresponding switch of the network, the acquisition at all of the switches makes it possible to assure acquisition of all of the messages at less cost in regard to the number of network segments that would have to be monitored in the prior art solutions.

In addition, by managing the operation of monitoring ports via a network that is parallel—the switch being third relative to the AFDX network—to the communication network, for example the AFDX network, the transmission of parasitic data to the latter is prevented. In this case, this leakproof relationship between the two networks is assured, while preventing any emission from dedicated/monitoring tools to the ADCN network.

In one embodiment, at least one of the consuming applications is the simulation unit. Thus the messages emitted over the network by the real computers may be acquired simply by the simulation unit, without extra cost. In this way, in fact, the simulation unit acquires only one copy of each message, which it is able to redirect the target simulation models, whereas in normal use it may be led to acquire several copies of a given message for just as many target models. In this way the processing load for acquisition by this simulation unit is limited.

In particular, the said third switch forms part of adaptation means provided between the said simulation unit and the said communication network. This concerns, for example, conversion of cabling without electrical adaptation. In this way, in a simple configuration, the same acquired messages are used for functioning of the simulation (therefore for the simulation unit and its models) and for all of the other consuming applications.

In particular, the duplication of data takes place within the adaptation means after the said adaptation (conversion of cabling, for example). This adaptation distinctly delimits the airplane domain (the network and the real computers) from the simulation domain (the simulation unit). Thus the configuration proposed here offers manipulation of the data mainly in the simulation domain, which is generally related to a traditional information technology network, therefore simpler to employ.

According to one characteristic of the invention, the said third switch is configured to aggregate the data of a plurality of input ports before transmission over a given output port. This configuration makes it possible to satisfy precise needs of consuming applications potentially devoid of processing means. In addition, by virtue of this preprocessing by combination/aggregation, savings are achieved in terms of output ports used to satisfy a larger number of consuming applications, given that the switches generally have a limited number of ports.

In one embodiment, the said third switch is configured to filter the said data of a plurality of input ports before emission over an output port. This other preprocessing also makes it possible to produce data that are usable more directly by the consuming applications. In particular, the said filtering comprises the selection of data originating from at least one predefined real or simulated computer. In other words, it involves a filtering according to the message sender. Alternatively or in combination, the criterion of recipient computer may also be taken into account. In particular, the filtering may be applied to already aggregated data.

In one embodiment of the invention, the said third switch is configured by means of a configuration file defining static rules of switching of the input ports with the output ports of the third switch. In this way the configuration of the switch to meet new demands or constraints can be achieved simply. It additionally is noted that this configuration mechanism is compatible with certain switches on shelves.

In particular, the said configuration file additionally defines external cabling between the ports of the third switch and the ports of the equipment items to which it is connected. By virtue of this provision, a map of connections to be made over the third switch can be generated rapidly with the aid of the configuration file. This map permits an operator to connect the different equipment items to the third switch without difficulty or multiple verifications.

According to a particular characteristic, the said static rules define the aggregation by concatenation of data originating from several input ports and the filtering by selection of at least one data-emitting computer.

In one embodiment, the third switch presents a plurality of sets of output ports identically duplicating the data of all of the input ports, and another set of configurable output ports for generating outputs that concatenate and/or filter several input ports. The configuration here makes it possible to satisfy both the needs of time-invariant applications for which all of the data of the monitored ports are transmitted (for example, the simulation unit, which identically recovers all of the messages) and the more specific and more temporary needs of particular tools. Again, the aggregation of several inputs for one output satisfying these specific needs efficiently uses the resources of the switch and especially the number of output ports.

It is understood, of course, that the configuration of the other set may be achieved automatically by means of the configuration file alluded to hereinabove.

Correlatively, the invention relates to a method for operation of a system for simulating or testing an aeronautic computer network architecture, the system comprising a communication network comprising a plurality of switches; real computers connected to the network respectively at one of the switches, referred to as corresponding switch; and a simulation unit simulating at least one computer and connected to the network at at least one switch referred to as corresponding switch, characterized in that the said method comprises:

reception, at input ports of a switch, referred to as third switch, of data acquired at the monitoring ports of the said corresponding switches and emitted by the said computers over the network, and

duplication of the said data for emission over a plurality of output ports of the third switch, to which a plurality of consuming applications is connected.

Optionally, the method may comprise steps relating to the characteristics of the system described in the foregoing.

### BRIEF DESCRIPTION OF THE FIGURES

Other features and advantages of the invention will become more apparent in the description hereinafter, illustrated by the attached drawings, wherein:

FIG. 1 represents a system for simulating an on-board computer architecture;

FIG. 2 represents the system of FIG. 1, integrating the object of the invention according to one embodiment;

FIG. 3 illustrates the third switch of FIG. 2; and

FIG. 4 represents a simplified excerpt of a file for configuration of the third switch of FIG. 2.

### DETAILED DESCRIPTION OF AN EMBODIMENT OF THE INVENTION

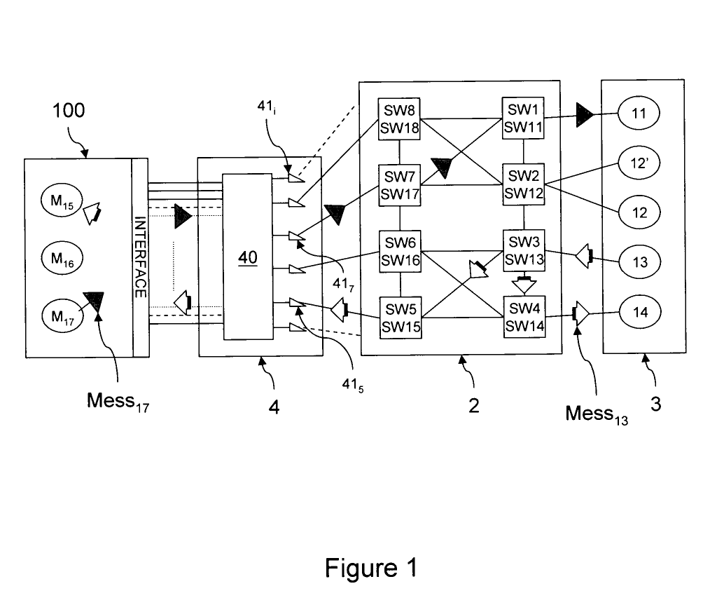

An ADCN network intended to equip an aircraft and having specifications adapted to the air domain has been shown on FIG. 1. This network is based on the AFDX communication technology, whose prerequisites pertaining to service quality are intended to assure real-time use.

This network 2, which is referred to hereinafter as AFDX network in conjunction with the associated communication technology, interconnects a plurality of on-board equipment items 11, 12, 12′, 13, 14 with one another, or in other words equipment items performing functions specific to the aircraft, such as an automatic pilot, speed transducers and altimeters, etc. These on-board equipment items are also referred to as computers or LRUs (“Line Replaceable Units”), and they define domain 3 of real computers, which in practice comprise several dozen computers. In the on-board systems, it is common practice for the computers to be duplicated for issues of safety. Nevertheless, each redundant computer is a separate computer, and therefore it will not be treated differently hereinafter.

The connections between equipment items of the network are made via cabling and connectors of a first type, for example Starquad cables and Quadrax connectors.

Network 2 is a digital switching network in which different switches SW1-SW8 point the data being transported from one AFDX bus to another AFDX bus segment. These switches are seen here as pointing equipment items that do not alter the content of the data being transported. A traditional network diagram, as represented in the figure, comprises eight network switches, to which there is connected the set of real computers, each network switch being present redundantly (SW11-SW-18 respectively), in such a way as to form two parallel networks: one nominal, the other redundant.

As is evident in the figure, each computer 11-14 of network 2 is connected directly to a switch referred to as “corresponding switch”, which is “its own” point of input into network 2 (respectively SW1-SW4, and SW11-SW14 for the redundant switches). Several computers (12, 12′) may be connected to a given corresponding switch.

The exchanges of data between these different computers 11-14 take place in the AFDX format and in non-connected mode of multibroadcasting (“multicast”) type, or in other words a transmission of type 1 to N recipients. This transmission mode is employed by means of a high-level protocol (above UDP/IP) based on the notion of virtual link (“virtual link” or VL), which statically defines rules for routing of messages at each switch SWi. This initial configuration of switches for pointing the data may be established with the aid of a configuration file defining the network architecture (or topology).

Also shown in this figure is a simulation or test unit 100, intended to simulate, during aircraft development or test phases, certain computers provided in the on-board system. Here, computers 15 to 17 are simulated via simulation models M₁₅ to M₁₇. These models are executed by the simulation unit under control of a global simulation management software program. The simulations are generally aimed at verifying the functioning of one or more new equipment items in the network.

Of course, the number of simulated computers may evolve in the course of test and development phases, by addition or removal (activation/deactivation) of a simulation model.

Simulation unit 100 is generally employed on a personal computer or a traditional information technology server, and is connected to other equipment items with the aid of cabling and connectors of a second type, for example traditional Ethernet cables equipped with FTP100/RJ45 connectors.

To interface the simulation domain, that is to say here simulation unit 100, with the airplane domain, here AFDX network 2 and real computers 11-14, there is provided an adaptation layer represented here by block 4.

This adaptation layer 4 comprises in particular an AFDX-Ethernet cabling converter 40 without electrical adaptation in order to make the connectors of the first type correspond with those of the second type, as well as connection racks 41 specific to each simulation model Mᵢ (rack 41₁₇ corresponding to model M₁₇ and therefore to real computer 17), and substituting, in the AFDX network, for the real computers to be simulated in the AFDX network.

By making a rack 41ᵢ substitute for a real computer i or vice versa in the network, the number of simulated computers is made to evolve. Furthermore, the correspondence between rack 41ᵢ and real computers i makes it possible to preserve the network topology during the substitution, because in this way the connection of computers i/model Mᵢ with the corresponding network switch SWi is preserved.

A given switch SWᵢ may at the same time be the corresponding switch of one or more real computers and of one or more simulated computers.

During simulation operations, simulation unit 100 guarantees that the communications concerning a simulation model are propagated exclusively via the corresponding rack.

Two messages transmitted over network 2 now are considered, one Mess₁₃, represented by open arrows and transmitted by computer 13 computers 14 (real) and 15 (simulated) and the other being Mess₁₇, represented by solid arrows and transmitted by simulated computer 17 real computer 11. As represented in the figure, message Mess₁₃ is propagated via switches SW3, SW4 and SW5 (and their redundant counterparts in the redundant network), statically configured beforehand, computers 14 and 15. Because the latter is simulated, the message passes through adaptation rack 4 via connection rack 41₁₅ and is transmitted within the simulation unit for processing by model M₁₅.

Similarly, message Mess₁₇ follows an inverse path along a virtual path VL defined with computer 11, via rack 41₁₇ and switch SW₇/SW₁₇.

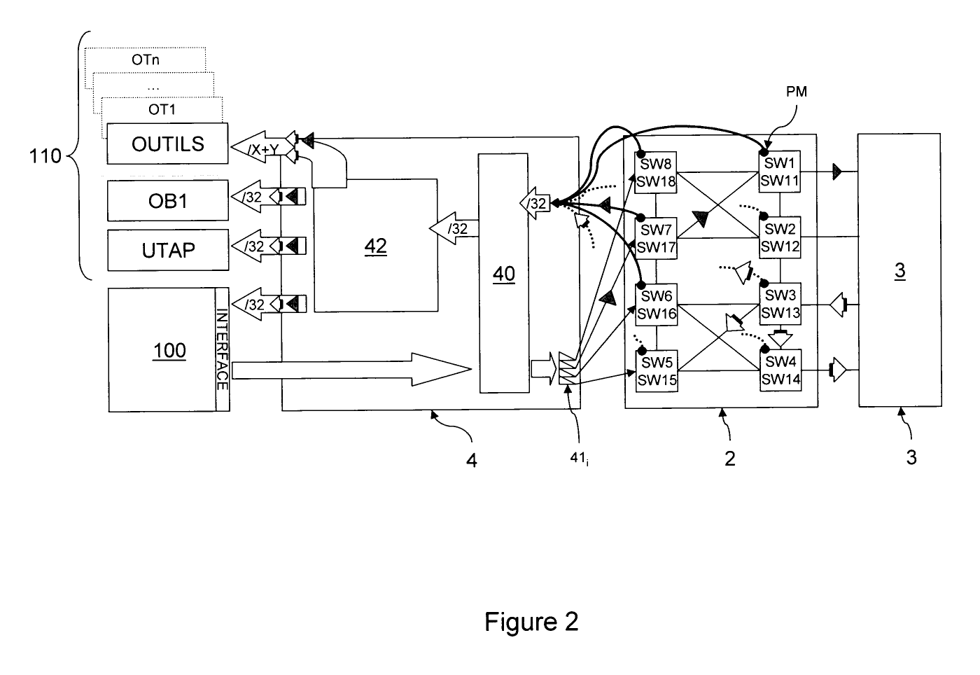

FIG. 2 represents an embodiment of the invention in which adaptation module 4 additionally comprises a switching means 42, for example a switch on shelf equipped with 192 usable physical ports.

Each switch SWi of AFDX network 2 possesses one or more monitoring ports, also known as ports of “monitoring” PM, over which they automatically emit a copy of each message received from a computer directly connected thereto. By virtue of the static definition of the network topology, each switch SWi is capable of identifying the preceding device relaying messages that it receives (either another switch or the message source directly) and of avoiding retransmitting, over the monitoring port, the messages that have already transited via other switches SWi.

Switches SWi used in the air domain present two monitoring ports PM₁ and PM₂, for example.

In the configuration of the invention, each monitoring port of switches SWi of network 2 is connected to a physical input port of switch 42. In our example hereinabove, there are therefore 32 monitoring ports and 32 corresponding physical input ports PE.

To simplify the architecture, it is possible simply to connect the monitoring ports of the switches referred to as “corresponding”, or in other words those to which at least one computer (whether or not simulated) is directly connected. In fact, the switches that are not “corresponding” will not broadcast any message over their monitoring ports. In this way the number of input ports PE being used is reduced.

The messages transmitted over network 2 thus are automatically duplicated at the “corresponding” switches SWi, then transmitted to switch 42 via the monitoring ports (see the bold, continuous or dotted lines of the figure), after cabling adaptation by converter 40. The figure also shows the propagation of a copy of messages Mess₁₃ and Mess₁₇ (open and solid triangles) along this path.

The output ports of switch 42 then are connected to the input ports of a plurality of applications consuming these information items, which applications are represented on the left part of the figure.

The first consuming application is simulation unit 100, which in this way is able to recover the messages Mess emitted over the network as a single copy, whereas in the absence of switch 42 a given message intended for two simulated computers would have to be acquired two times at the two corresponding racks. In view of the large number of computers that are sometimes simulated, this simple acquisition may reduce the processing load of simulation unit 100 considerably. Thus it is observed that racks 41 are used only in the output direction (from simulation unit 100).

Since these copies recovered over the monitoring ports do not take the state of network 2 into account (availabilities or otherwise of switches SWi), the use of these copies by simulation unit 100 may be additionally contingent upon the availability of virtual links, along which these copies must be transmitted: for example, simulation unit 100 makes sure that all of the switches SWi of a path VL are operational before processing the copy of a message that must be broadcast along this path.

Other consuming applications 110, distinct from the simulation unit, are:

temporary tools connected to user access points and denoted UTAP (User Test Access Point), via which the user is able to observe any data traffic of a monitoring port. By way of example, the access points may be simple flying leads, to which the user connects, as the case may be, an AFDX message interpreter;

tools consuming raw monitoring ports (or in other words without message processing), denoted OBi (raw tools), for example instrumentation and analysis tools;

tools consuming all or part of monitoring ports capable of processing messages by aggregation and/or filtering, denoted OTi (processed tools).

The messages acquired at the monitoring ports PM of switches SWi are duplicated within switch 42 in order to supply each of consuming applications 100/110 at the input. For the example of eight redundant switches and two monitoring ports per switch SWi, 32 signals originating from these monitoring ports are manipulated, as illustrated by the number “32” in the arrows arriving in and leaving converter 40 in FIG. 2.

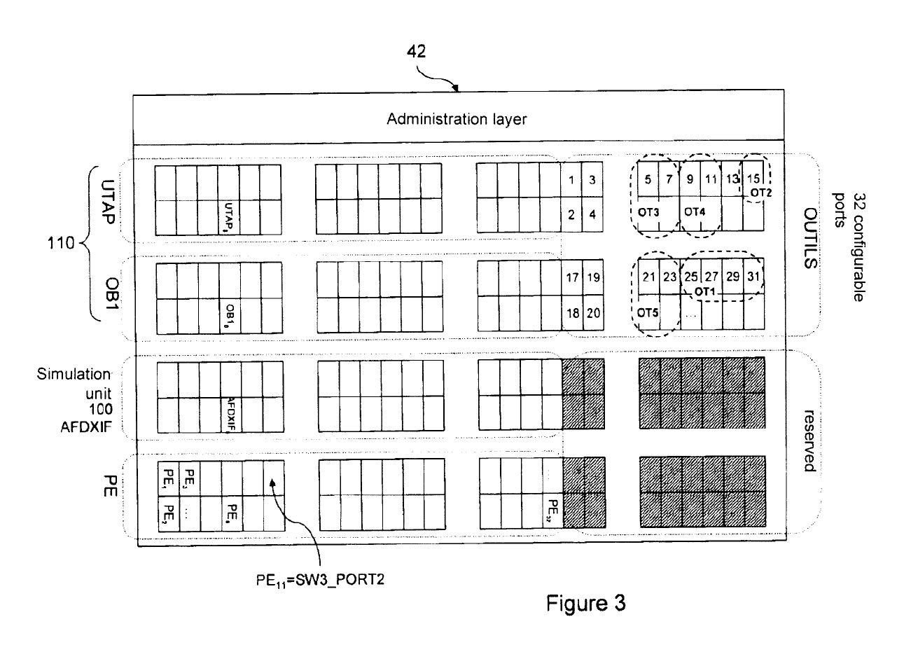

FIG. 3 illustrates the front of a third switch 42 in network 2 equipped with 192 physical ports, of which 32 ports are input ports PE dedicated to acquisition of signals recovered at the monitoring ports PM and of messages circulating therein.

Switch 42 also has a plurality of sets of output ports that identically duplicate the data of the set of input ports. In FIG. 3, these sets are identified by the recipient consuming applications, or in other words UTAP, OB1 and simulation unit 100, denoted AFDXIF. A symmetric distribution of the ports across these different sets is preferably envisioned, meaning that the output ports having the same physical position within their respective set as an input port in set PE distributes the same data acquired at this input port: for example, the data acquired over port PE₈ are duplicated ports UTAP₈, OB1₈ and AFDXIF₈. To supply each of the consuming applications UTAP, OB1 and 100, there is used direct cabling with the aid of cables of the second type (or in other words in the simulation domain) between each output port of each set and the input ports of the corresponding consuming equipment items.

Switch 42 also has another set of output ports, which can be configured dynamically according to the use made of them. These ports are identified by the notation OUTILS [TOOLS] in the figure.

These output ports are processed by tools that are more specific than those intended for the first sets AFDXIF, UTAP, OBi. They are OTi tools. 32 ports form this set and are connected to the consuming applications OTi by cables of the second type.

Finally, 32 other ports may be reserved, for example for establishment of identical duplications for other consuming applications OBi.

The possibility of dynamically configuring the OUTILS ports assures adaptation of the system to evolving needs regardless of the number of specific consuming applications or of the variable needs thereof.

In the configuration represented in FIG. 3, certain output ports of the set OUTILS are configured and used by the consuming applications whereas others are provided as emergency ports/available ports not yet assigned (for example, the ports numbered 1 to 4 and 17 to 20). In FIG. 2, X ports in use and Y emergency ports (X+Y=32 here) have been indicated for this purpose in the arrow directed toward OUTILS. The number of ports in use may vary in time according to the needs of consuming applications OUTILS and of the number thereof.

In view of the small number of available output ports OUTILS compared with the number of monitoring ports acquired and the number of consuming applications connected to this set OUTILS, switch 42 is additionally configured to perform processing operations between input ports PEᵢ and output ports OUTILSⱼ.

Two main processing operations may be employed in switch 42, or in other words:

aggregation of traffic flows originating from several monitoring ports (input ports PE), for example by concatenation of messages. In this way, composite outputs of several input ports are generated at certain output ports OUTILS;

filtering of output traffic flows according to one or more criteria. For example, a tool OB may need only traffic corresponding to an emitter computer or particular recipient. Such filtering according to the emitter/recipient before transmission over the port makes it possible, at less cost, to simplify the processing of data by the consuming application connected to this output port. In this way it is possible to use consuming equipment items having few resources.

These two processing operations may be employed independently of one another or consecutively, for example for aggregation of messages first, followed by filtering applied to the emitter,

Dynamic configuration of switch 42 is achieved mainly by transfer of a configuration file created by a user. This transfer may take place over an administration serial port or over an Ethernet port of switch 42.

The taking into account of the configuration file by the switch may be immediate and result in a quasi-instantaneous configuration, or be delayed until a subsequent reboot of switch 42 or an intentional action of an operator.

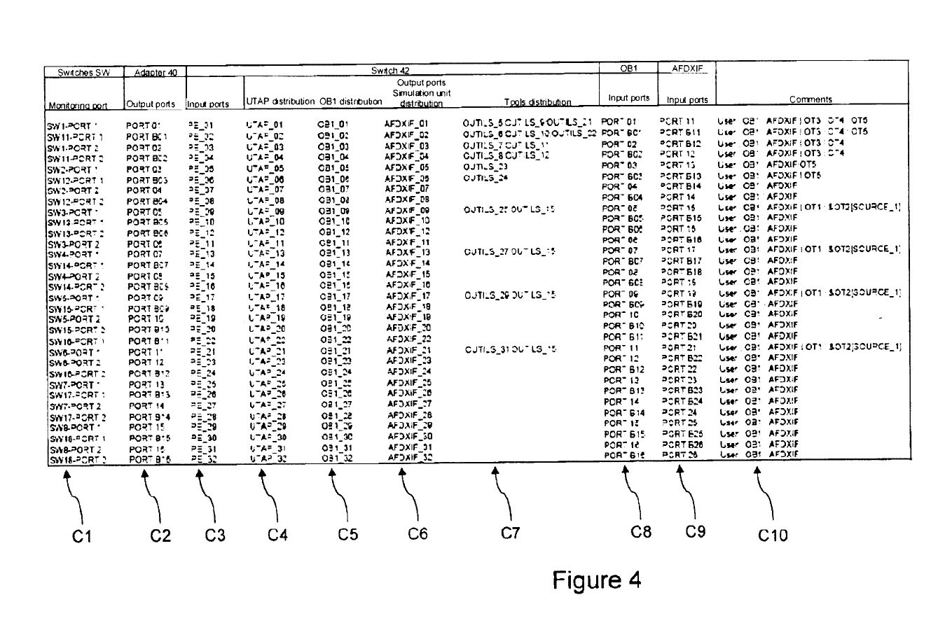

Conversion of an editable file into a configuration file in the language specific to the switch is provided, as the case may be, upstream from the file transfer. FIG. 4 presents a portion of an editable file provided for configuration of switch 42 in the state represented in FIG. 3.

The file defines the external cabling between the ports of switch 42 and the ports of equipment items 40/100/OB1 to which it is connected, as well as static rules for switching from input ports to output ports of the third switch.

To illustrate this file and the corresponding configuration, the line corresponding to monitoring port 2 of switch SW3 (SW3-PORT 2) is observed, for example.

This configuration line states that output port No. 06 [column C2] of adapter 40 supplies input port PE₁₁ [column C3]. This input port is duplicated [column C4-C6] output ports UTAP₁₁, OB1₁₁ (connected to input port No. 06 of equipment item OB1, see column C8) and AFDXIF₁₁ (connected to input port No. B16 of simulation unit 100, see column C9).

It is noted that no input port of an equipment item UTAP is indicated, because this generally involves flying leads available to users and therefore not connected permanently to an equipment item.

By taking the lines SW3_PORT 1, SW4_PORT 1, SW5_PORT 1 and SW6 _PORT 1, the configuration additionally provides that the messages acquired on these ports are transmitted respectively to output ports No. 25, 27, 29 and 31 of the set OUTILS, and are all transmitted to output port No. 15 of the set OUTILS [column C7].

In the comments column [column C10], there are indicated the applications consuming the data acquired at each monitoring port PM, separated by the character “|”. For example, the input PE_13 (SW4_PORT1) is used for the applications UTAP (see C4), OB1 (see C5), “AFDXIF” (or in other words, the simulation unit, see C6) and two more specific applications OT1 and OT2 connected to ports OUTILS (in the same order as column C7).

With this configuration, the switch provides an aggregation of messages originating from monitoring ports SW3_PORT 1, SW4_PORT 1, SW5_PORT 1 and SW6_PORT 1, in a common output signal at port No. 15 of the set OUTILS for application OT2. This aggregation is in particular the concatenation of messages acquired during a time interval over these monitoring ports PM.

The aggregation, cited hereinabove, output port OUTILS_15 additionally comprises filtering of data aggregated according to the name of the emitter, here the computer identified as SOURCE_1, which is indicated between brackets following the recipient application OT2 in the comments column. The “&” character preceding “OT2” in this column is a marker indicating to switch 42 that filtering must be applied.

The association of consuming applications with output ports OUTILS follows from the identical orders in which these and ports OUTILS are declared in columns C7 and C10. This is why the application OT2 and the port OUTILS_15, both last cited, correspond.

It is seen here that this editable file makes it possible to generate a map of connections to switch 42, as partly represented in FIG. 3, automatically and at less expense.

When switch 42 is configured with the aid of the configuration file of FIG. 4, the consuming applications 100, UTAP and OB1 receive all of the messages over 32 distinct ports corresponding to the 32 monitoring ports.

In addition, the applications OUTILS OT3 and OT3 respectively receive, over four distinct ports (connected respectively to OUTILS_5 to 8 and to OUTILS _9 to 12), the messages acquired at the two monitoring ports of switches SW1 and SW11 (redundancies of one another).

The application OUTILS OT5 receives, over four distinct ports, the messages acquired at monitoring ports No. 1 of switches SW1, SW2 and their redundancies SW11 and SW12.

The application OUTILS OT1 receives, over four distinct ports, the messages acquired at monitoring ports No. 1 of switches SW3 to SW6, without their redundancies.

Finally, the application OUTILS OT2 in turn receives, over a single port connected to output port OUTILS_15, the concatenation of messages originating from monitoring ports No. 1 of switches SW3 to SW6 and emitted exclusively by computer SOURCE_1.

The foregoing examples are merely some embodiments of the invention, which is not limited thereto.

In particular, switch 42 may be employed in the form of several interconnected switches on shelves. Nevertheless, the use of a single switch having a large number of usable ports makes it possible to offer a common supervision interface, permits common configuration of the set of ports, permits flexible assignment of sets of output ports, because it is not subject to the constraints of inter-switch connection, and in general offers a redundant supply.

Furthermore, switch 42 may be distinct from adaptation interface 4. In this case, it is possible to provide that simulation unit 100 acquires messages in traditional manner, directly over network 2 at racks 41, and that, in parallel, switch 42 connected to the monitoring ports supplies consuming applications UTAP, OBi and OTi as described in the foregoing.

1. A system for simulating or testing an aeronautic computer network architecture, the system comprising:
a communication network comprising a plurality of switches;
a plurality of real computers connected to the network respectively at one of the switches, referred to as corresponding switch; and
a simulation unit simulating at least one computer of the said architecture and connected to the network at at least one switch referred to as corresponding switch,
characterized in that the said system comprises:
a switch, referred to as third switch, which receives, at the input ports, data acquired at the monitoring ports of the said corresponding switches and emitted by the said computers over the network,
the third switch being configured to duplicate the said data over a plurality of output ports, to which a plurality of consuming applications is connected.

2. A system according to claim 1, wherein at least one of the consuming applications is the simulation unit.

3. A system according to claim 1 or 2, wherein the said third switch forms part of adaptation means provided between the said simulation unit and the said communication network.

4. A system according to claim 3, wherein the duplication of data takes place within the adaptation means after the said adaptation.

5. A system according to claim 1 or 2, wherein the said third switch is configured to aggregate the data of a plurality of input ports before transmission over a given output port.

6. A system according to claim 1 or 2, wherein the said third switch is configured to filter the said data of a plurality of input ports before emission over an output port.

7. A system according to claim 6, wherein the said filtering comprises the selection of data issued from at least one predefined real or simulated computer.

8. A system according to claim 1 or 2, wherein the said third switch is configured by means of a configuration file defining static rules of switching of the input ports with the output ports of the third switch.

9. A system according to claim 1 or 2, wherein the third switch presents a plurality of sets of output ports identically duplicating the data of all of the input ports, and another set of configurable output ports for generating outputs that concatenate and/or filter several input ports.

10. A method for operation of a system for simulating or testing an aeronautic computer network architecture, the system comprising a communication network comprising a plurality of switches; real computers connected to the network respectively at one of the switches, referred to as corresponding switch; and a simulation unit simulating at least one computer and connected to the network at at least one switch referred to as corresponding switch, characterized in that the said method comprises:
reception, at the input ports of a switch, referred to as third switch, of data acquired at the monitoring ports of the said corresponding switches and emitted by the said computers over the network, and
duplication of the said data for transmission over a plurality of output ports of the third switch, to which a plurality of consuming applications is connected.
